(19) United States
(12) Patent Application Publication
(10) Pub. No.: US 2025/0160249 A1
(43) Pub. Date: May 22, 2025

(54) Stereo Camera System

(71) Applicant: AGCO International GmbH, Neuhausen (CH)

(72) Inventors: Filip Slezák, Randers (DK); Morten Stigaard Laursen, Randers (DK); Martin Peter Christiansen, Randers (DK)

(21) Appl. No.: 18/825,335

(22) Filed: Sep. 5, 2024

(30) Foreign Application Priority Data
Nov. 16, 2023 (GB) 2317600.1

(51) Int. Cl. A01D 41/127; G06T 7/593; G06T 7/70

(52) U.S. Cl. CPC A01D 41/127; G06T 7/593; G06T 7/70; G06T 2207/10012; G06T 2207/30252

(57) ABSTRACT

A computer implemented method and associated control system for monitoring the operational use of an agricultural machine. Raw image data from a stereo camera system is processed through application of an epipolar image rectification to generate a rectified image data set. The rectified dataset is utilized to generate a disparity map indicative of depth within the image data, which is used as an input to one or more assisted or automated operational tasks for the agricultural machine.

### CROSS-REFERENCE TO RELATED APPLICATIONS

This application claims the benefit of the filing date of U. K. Provisional Patent Application 2317600.1, “Stereo Camera System,” filed Nov. 16, 2023, the entire disclosure of which is incorporated herein by reference.

### FIELD

Embodiments of the present disclosure relate generally to improvements in or relating to vision based sensor systems, and in particular stereo camera systems. The present disclosure extends to sensor systems for agricultural machines, such as combine harvesters.

### BACKGROUND

The determination or estimation of the three-dimensional structure of an environment is important for numerous applications, such as automated or at least partly automated driving tasks and robotics, including in an agricultural working environment. Active (or “transceiver type”) sensors such as LiDAR or RADAR systems can provide accurate distance estimation directly but come at a high financial cost and power requirement. This could make such an option unfeasible for certain tasks, such as in an agricultural context. Other sensing technologies include utilizing RGB cameras assembled in stereo configuration, providing a low cost solution with comparatively lower power requirements. However, in a camera-based system, distance and depth within an image of composite image has to be estimated algorithmically. A further drawback with known stereo camera systems specifically is their usability being constrained to relatively narrow fields of view (“FOV”).

It is an aim of an embodiment or embodiments of the present disclosure to overcome or at least partially mitigate problems associated with prior art solutions.

### BRIEF SUMMARY

Some embodiments of the disclosure include a computer implemented method for monitoring the operational use of an agricultural machine, the method comprising: obtaining raw image data from a stereo camera system of or otherwise associated with the agricultural machine; processing the raw image data through application of an image rectification to generate a rectified image data set; applying a stereo-matching algorithm on the rectified image data set to generate a disparity map; and controlling operation of one or more operable components of or otherwise associated with the agricultural machine in dependence on the generated disparity map; wherein the image rectification comprises an epipolar rectification.

Advantageously, the present disclosure utilizes an image rectification which comprises an epipolar rectification. This advantageously maintains a depth estimation accuracy at wider fields of view, when compared with prior art techniques. This may enable the use of, for example, fisheye lenses or other wide angle optics for use in distance based vision systems, such as a stereo camera system.

The method may comprise converting the disparity map to a corresponding 3D representation. This conversion may utilize one or more intrinsic camera parameters. The 3D representation may comprise a distance map, a pointcloud, or a voxel-based representation, for example. The method may comprise controlling operation of one or more operable components of or otherwise associated with the agricultural machine in dependence on the 3D representation.

The epipolar rectification may comprise an equidistant epipolar rectification.

The epipolar rectification may be formulated in dependence on one or more characteristics of the stereo camera system. The one or more characteristics may comprise an orientation or relative arrangement. For instance, the epipolar rectification may comprise a remapping of the raw image data which aligns epipolar lines in the raw image data in dependence on an axis relative to the orientation and/or relative arrangement of the stereo camera system.

The method may comprise analyzing the generated disparity map to identify one or more operational parameters associated with the agricultural machine. The method may comprise analyzing a generated 3D representation from the disparity map to identify one or more operational parameters associated with the agricultural machine.

Where the machine is performing an operational task, the method may comprise identifying one or more operational parameters associated with that task, which may, for example, correspond to a measure of the effectiveness, efficiency or the like of the operational task. This may include determining a relative position of one or more operable components of the machine and/or implements operably coupled thereto. The method may comprise comparing the determined position with an expected position from respective operational settings for the machine. In this way, the image data from the stereo camera system may be utilized to monitor the machines operation against its operational setup. This may advantageously utilize the image data to determine, for example, a relative position of an unloading auger of the machine, or a coupled implement, e.g. with respect to the machine, an associated machine or vehicle, or an environment—e.g. a header position with respect to crop material to be harvested, or an implement position with respect to a ground surface.

The method may comprise utilizing the generated disparity map to identify a relative position of one or more objects, vehicles, machines or the like in the operating environment of the agricultural machine. This may be used, for instance, in an at least partly automated guidance system for the machine, such as an obstacle avoidance system, or a row guidance system.

The method may comprise identifying, from the generated disparity map, the relative position of a cooperative machine within the machines working environment. This may include determining the relative position of a collection vehicle into which the agricultural machine may unload crop material, in use. The method may extend to at least party automating an unloading operation of crop material from the agricultural machine to the collection vehicle in dependence on the determined position, which may include controlling operable parameters of an unloading auger of the machine, including an operational speed of components thereof, and/or an operating position with respect to the collection vehicle.

A further aspect provides a control system comprising one or more controllers configured to perform the operational steps of the preceding aspect of the disclosure.

The one or more controllers may collectively comprise an input (e.g. an electronic input) for receiving one or more input signals. The one or more input signals may comprise the raw image data. The one or more controllers may collectively comprise one or more processors (e.g. electronic processors) operable to execute computer readable instructions for controlling operation of the control system, for example, to process the raw image data through application of the image rectification, stereo-matching algorithm or generation of the disparity map. The one or more processors may be operable to generate one or more control signals for controlling operation of the one or more operational components. The one or more controllers may collectively comprise an output (e.g. an electronic output) for outputting the one or more control signals.

According to a further aspect of the disclosure, there is provided a stereo camera system comprising a pair of cameras; wherein the system further comprises or is controllable under operation of the control system of the preceding aspect of the disclosure.

Another aspect provides an agricultural machine comprising the stereo camera system of the preceding aspect. The agricultural machine may comprise a harvesting machine, such as a combine harvester.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIGS. 1-6 illustrate theoretical and experimental analysis of aspects of the present disclosure, illustrating the operational use and associated advantages realized;

FIG. 7 is a simplified cross-sectional view of an agricultural machine embodying aspects of the present disclosure;

FIG. 8 is a schematic diagram illustrating a system of the present disclosure; and

FIGS. 9-11 are a series of images illustrating the improvements realized by the present disclosure over prior art solutions.

### DETAILED DESCRIPTION

The present disclosure relates to improvements in and relating to stereo camera technology, and specifically for stereo camera systems suitable for use on working machines, such as agricultural machines, e.g. for monitoring and/or (at least partly) automating operation of an agricultural operation performed by the machine.

### Stereo Cameras—Background and Prior Solutions

The fundamental principle of distance estimation using stereo cameras is triangulation. As the stereo cameras observe the scene from two slightly different positions, typically a horizontal displacement known as the baseline, a point in 3D will be projected to slightly different locations on the two image planes, also referred to as parallax. To recover the 3D position, this process is performed in reverse; a point in the image formed by the left camera is identified in the image formed by the right camera, and their relative displacement (parallax) is used to identify the 3D location of that point using intrinsic and extrinsic parameters of the stereo cameras. Therefore, the act of determining the 3D structure of the environment is analogous of finding correspondences between the two images.

Furthermore, the fixed relative position of the cameras reduces the search space of a given point in the left image to a line in the right image, also referred to as the epipolar line. The line contains a continuous set of all the possible points along which the corresponding point might be located. While this provides a significant simplification, in unrectified stereo using the raw image from the cameras directly, the epipolar lines will be curved, greatly complicating the search by making it significantly more computationally expensive and lacking a standardized form. To address this, a common practice is to remap the raw images into a virtual camera representation with ideal properties, where the epipolar lines are aligned with the rows of the image, removing the vertical parallax, and preserving only the horizontal displacement, (also referred to as “disparity”). Consequently, the correspondence finding problem is significantly reduced, resembling a one dimensional version of an optical flow algorithm.

The most popular image representation in computer vision is a pinhole representation (also called “perspective”) as it reproduces visuals representing the human visual experience while maintaining linear properties in the image data which is computationally easier to manage. Furthermore, raw stereo images remapped into ideal pinhole images naturally follow epipolar constraints, and the distance can be easily recovered using linear operations, as it is simply an inverse of the disparity. The has led to prior solutions focusing solely on the disparity estimation problem.

However, the pinhole camera model has an inherent limitation. Specifically, it is unsuitable for expressing a wide field of view due to representation inefficiency, for instance when utilizing a camera or cameras equipped with a different lens, typically a wide-angle fisheye lens. As is known, such lenses can effectively capture image data at more than 180 degrees FOV, with some lenses even reaching 125 degrees. It would be beneficial to utilize stereo cameras equipped with fisheye lenses for applications where wide FOV is desirable, e.g. in an agricultural context where a view up to and beyond 180 degrees, e.g. alongside an agricultural machine, or across a full width of a wider header or other implements.

Using cameras with fisheye lenses in stereo setups breaks numerous assumptions present in conventional pinhole stereo camera setups. For instance, image rectification becomes more problematic as the rectified epipolar stereo camera model has very different projective properties compared to the raw fisheye image. Furthermore, the recovery of the distance measurements from the disparity map becomes non-linear, creating a complicated relationship between the estimated disparity and distance to objects.

### Present Disclosure

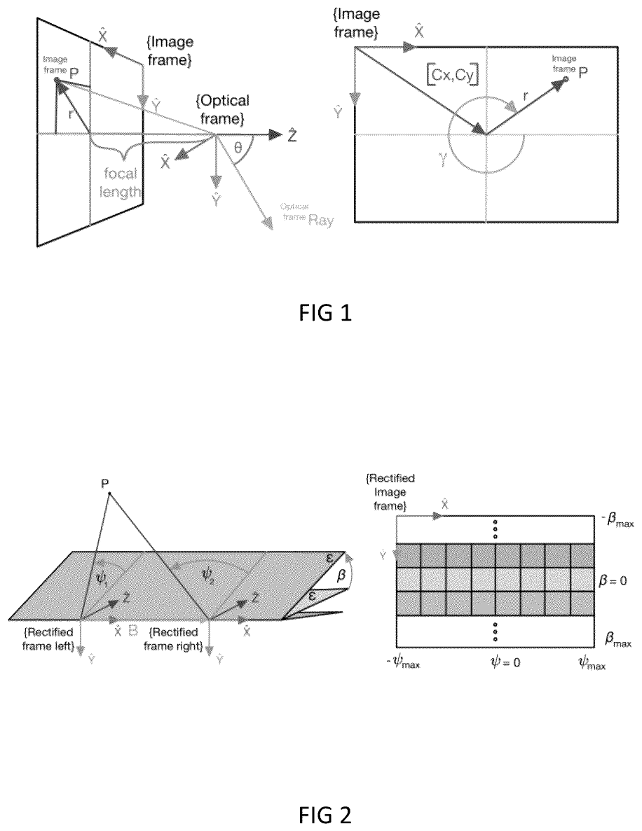

Cameras are 2D sensors, but even though the 3D nature of the environment is lost during projection, each pixel has an associated 3D ray direction from which the photometric information was captured. Typically, the relationship between the pixel coordinates in the raw image frame and 376 corresponding rays is expressed with an appropriate camera model. Utilization of this relationship is a prerequisite for structure estimation, as the distances are calculated by finding intersections of rays from both cameras. Typically, the relationship between pixel locations and their corresponding ray directions follow complicated non-linear relationship, as they are subject to imperfections of the particular optical system used to capture them. However, if the relationship is known, the raw images can be remapped into a representation following a custom camera model with selected properties suited with the task, specifically here as epipolar lines aligned with the rows of the image. While numerous wide-angle camera models have been used in prior solutions, used here is a Kannala Brandt model, as it combines the equidistant model, also commonly referred to as the f-θ. The model also contains distortion coefficients which model the deviation from the equidistant model. For practical purposes, this model can be considered ideal, as it is a common practice for lens manufacturers to label their wide-angle lenses by a % deviation from the ideal f-θ. The following details how a 3D ray relative to the camera's optical frame ^{Optical frame}Ray can be mapped to the image coordinates ^{Image frame}P using a Kannala-Brandt model, illustrated in FIG. 1.

The projection function π[^{Optical frame}Ray, i] maps a ray vector ^{Optical frame} Ray to a point in the image frame ^{Image frame}P using intrinsic parameters i=[fx fy Cx Cy d1 d2 d3 d4]^{T}.

$$π {[}^{Optical frame} Ray , i ] = [ \begin{matrix}{f}_{x} {θ}_{d} \frac{x}{r} \\ {f}_{y} {θ}_{d} \frac{y}{r}\end{matrix} ] + [ \begin{matrix}{c}_{x} \\ {c}_{y}\end{matrix} ] \qquad ( 1 )$$

$${[}^{Optical frame} Ray = [ \begin{matrix}x \\ y \\ z\end{matrix} ] \qquad ( 2 )$$

$$r = \sqrt{{x}^{2} + {y}^{2}} \qquad ( 3 )$$

$${θ}_{d} = θ ( 1 + {k}_{1} {θ}^{2} + {k}_{2} {θ}^{4} + {k}_{3} {θ}^{6} + {k}_{4} {θ}^{8} ) \qquad ( 4 )$$

$$θ = a tan 2 ( r , z ) \qquad ( 5 )$$

Epipolar geometry is used to minimize the search space for correspondences. Due to triangulation, a ray from one camera can be intersected only by a ray from the second camera that is co-planar. While the search space reduction can be calculated for raw images, it tends to be mathematically complicated to work with due to the non-linear projection of the epipolar line, requiring additional methods such as generating trajectory fields. Here, however, raw images from a stereo pair can be remapped to a mathematically favorable representation using known intrinsic and extrinsic parameters of the raw stereo camera pair. Projective functions, discussed above, outline how a direction vector maps to a location in the image plane. If a direction vector is defined for each pixel, also typically referred to as a “raxel”, a sub-pixel location in the raw image can be used to generate a novel representation using a remapping function. Therefore, the problem formulation involves generating a ray direction for each pixel in a virtual image that follows rules which simplify the correspondence search. To make stereo images compatible with existing stereo-matching algorithms, the only constraint is that each row in the stereo-rectified image corresponds to co-planar vectors relative to the raw cameras' optical frames. The principle can be seen in FIG. 2.

If it is assumed that the stereo-rectified images are of a shape [dimx, dimy] with the principal point in the centre [Cx, Cy]=[dimx/2, dimy/2], it can also be assumed that the angle within the epipolar plane ψ=f(x*) where x*=x−Cx and epipolar angle β=f(y*) where y*=y−Cy, and y* representing the conditioned coordinates. For an equidistant representation, the angular sampling between the direction vectors is constant. Therefore, assuming the field of view within the epipolar plane is 180 degrees, meaning ψmax=90 degrees, defines the rectified stereo image focal length fx=Cx/ψmax. Similarly, βmax=90 degrees and fy=Cy/βmax. Consequently, a coordinate at a point x, y in the rectified image plane has an associated ray vector ^{Rectified frame}Ray, generated by equations 6 and 7.

$$ψ = {x}^{*} / {f}_{x} , β = {y}^{*} / {f}_{y} \qquad ( 6 )$$

$${Rectified frame}^{} Ray = [ \begin{matrix}cos ( ψ ) \\ - sin ( ψ ) sin ( β ) \\ sin ( ψ ) cos ( β )\end{matrix} ] \qquad ( 7 )$$

Lastly, even though the real cameras will be assembled parallel, there will likely be an undesirable relative rotation, violating the strict parallel constraint of the virtual stereo setup, where the cameras are only displaced in the x-direction of the rectified optical frame by baseline B, with no relative rotation. However, the relative rotation can be taken into account by finding a necessary corrective rotation relative to each raw camera. As the virtual images are defined in the raxel representation, the direction of the representation can be easily rotated simply by multiplying them by a corresponding corrective rotation matrix. Afterwards, all the ray vectors will be represented relative to the raw images, and equation 1 can be used to generate a table for each coordinate in the rectified frame to the raw image. Consequently, every further operation will operate directly on the rectified images.

Traditional stereo matching algorithms can be directly employed on the rectified representation, generating a disparity D for each pixel [x,y] in the left image. Then, the direction vectors ψ1 and ψ2 can be recovered using equation 6 for coordinates [x,y] in the left image and [x-D,y] in the right image. Then, the 3D coordinates corresponding to a pixel [x,y] can be calculated using equations 8 and 9.

$${Epipolar plane}^{} P = ( \frac{B sin ( {ψ}_{1} ) cos ( {ψ}_{2} )}{sin ( {ψ}_{1} - {ψ}_{2} )} , \frac{B cos ( {ψ}_{1} ) cos ( {ψ}_{2} )}{sin ( {ψ}_{1} - {ψ}_{2} )} ) \qquad ( 8 )$$

$${}^{Rectified frame} P = [ \begin{matrix}{Epipolar plane}^{} {P}_{x} \\ {Epipolar plane}^{} {P}_{y} sin ( β ) \\ {Epipolar plane}^{} {P}_{y} cos ( β )\end{matrix} ] \qquad ( 9 )$$

### Distance Estimation—Proof of Concept and Improvement.

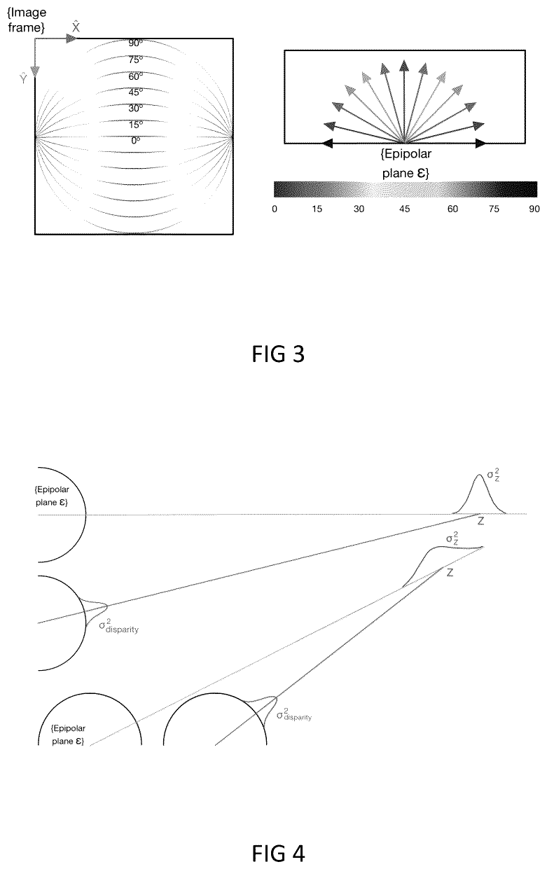

While the present disclosure extends to utilizing the stereo rectified images for further processing and ultimately controlling operation of one or more operable components of or otherwise associated with an agricultural machine, for example, it is worth examining how is the raw image is sampled to produce them. FIG. 3 shows the back-projection of the raxels, selecting rows corresponding to 15 degree increments of epipolar angles β. Furthermore, a jet color scheme is used to represent the angles ψ within the epipolar plane.

Enforcing epipolar constraints will result in non-homogeneous sampling of the raw image as ψ approaches 90 degree, explaining the apparent distortion around the edges. It can also be observed that there is a linear relationship between ψ and pixel distances along the epipolar lines on the raw images, which supports the idea of searching for correspondences inside the raw images or similar representations such as spherical geodesic grid. However, ensuring accurate and uniform correspondence search accuracy throughout the entire image does not equate to uniform accuracy of the distance estimates. The reason is the non-linear relationship between correspondences at different parts of the image and the triangulated depth.

To isolate the contribution of triangulation to the variance of distance estimates, let us suppose that the correspondence finding algorithm would be unaffected by the distortions and there exists enough information to compute the matches robustly. Then, we can assume that the variance σ²_{disparity} of the disparity estimation, regardless of whether the search happens on raw or stereo-rectified images to be constant.

$$∀ ( x , y ) , {σ}_{disparity}^{2} ( x , y ) = C$$

Using the relationship M, which maps a disparity D at a given pixel to a distance Z, a Monte Carlo analysis can be performed by sampling N instances Di from a probability distribution with variance σ²_{disparity}. For each sampled instance Dᵢ, we compute a corresponding distance estimate Zᵢ using the relationship Zᵢ=M(Dᵢ). The variance of the distance estimates azz is then estimated by:

$${σ}_{Z}^{2} \approx \frac{1}{N - 1} {\sum }_{i = 1}^{N} {( M ( {D}_{i} ) - \overline{M ( D )} )}^{2} \qquad ( 10 )$$

Where M̅(̅D̅)̅ is the sample mean of the computed distance estimates:

$$\overline{M ( D )} = \frac{1}{N} {\sum }_{i = 1}^{N} ( M ( {D}_{i} ) \qquad ( 11 )$$

An intuitive example of the variance propagation process through triangulation can be seen in the FIG. 4.

Monte Carlo analysis can be performed by simulating a distance measurement to a particle as it moves throughout the FOV of the camera in two circular trajectories, in the illustrated example maintaining a constant distance of 10 meters. This particular setting was chosen as it reflects the common requirements of omnidirectional stereo systems—measure distances to objects throughout a wide field of view. At each point in the trajectory, a ground truth disparity measurements can be obtained by projecting the 3D position of the particle to the rectified image planes, using equations outlined and discussed in detail above. Then the ground truth disparity will equate to a difference between the projected x coordinates.

Two trajectories were chosen, varying ψ from 0 degrees-90 degrees, and maintaining β at 0 degrees and varying β from 0 degrees-90 degrees and maintaining ψ at 0 degrees. The ground truth disparities are plotted in FIG. 5. It can be seen that as the particle approaches 90 degrees of ψ, the ground truth disparity approaches 0 while is remaining constant in the β direction.

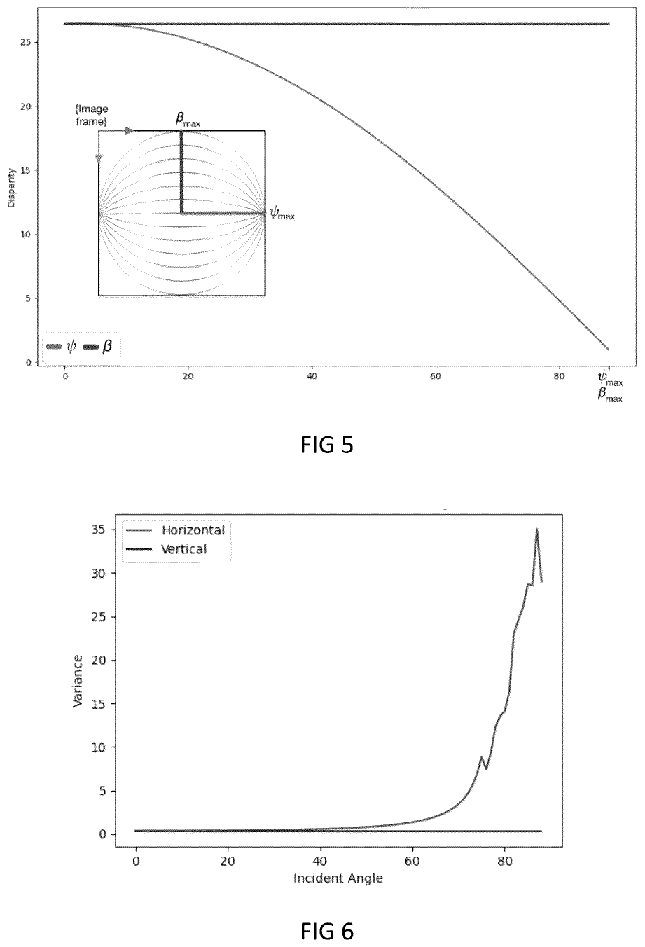

To isolate the effects of the stereo-matching algorithm and the non-linear distance triangulation, an assumption is made that the variance of the disparity estimation is constant throughout the image, completely unaffected by the perceived distortion, especially around the pole regions caused by non-homogenous sampling. The particle position is sampled at 1 degree increments for ψ and β directions respectively. At each angle increment, 300 random instances are sampled from a distribution with known variance σ²_{disparity} and added to the ground truth disparity D as a noise term. Corresponding distances are computed, and the distance variance σ²_{Z} is calculated using equations 10 and 11 outlined above. FIG. 6 visualizes the relationship between the angles ψ and β and the expected variance σ²_{Z} of the distance measurement given that the disparity variance σ² disparity remains constant throughout the image.

It has therefore been identified that the contribution of the triangulation to the error is substantial, and even an ideal correspondence matching algorithm whose performance would not degrade due to non-homogenous resampling would achieve poor distance measurement results at high values of ψ. On the other hand, the measurement accuracy remains constant throughout the whole range of the β. Considering the results outlined in FIG. 6, it is reasonable to suggest that the triangulation error limits the effective depth estimation to +−40 degrees ψ, with the limits in the β direction determined solely by the lens. Most importantly, the apparent distortion and triangulation error are related affecting the same parts of the image. In turn, equidistant stereo rectification coupled with conventional stereo matching algorithms might be sufficient to achieve the best results for wide-angle stereo depth estimation.

### Simulated Data

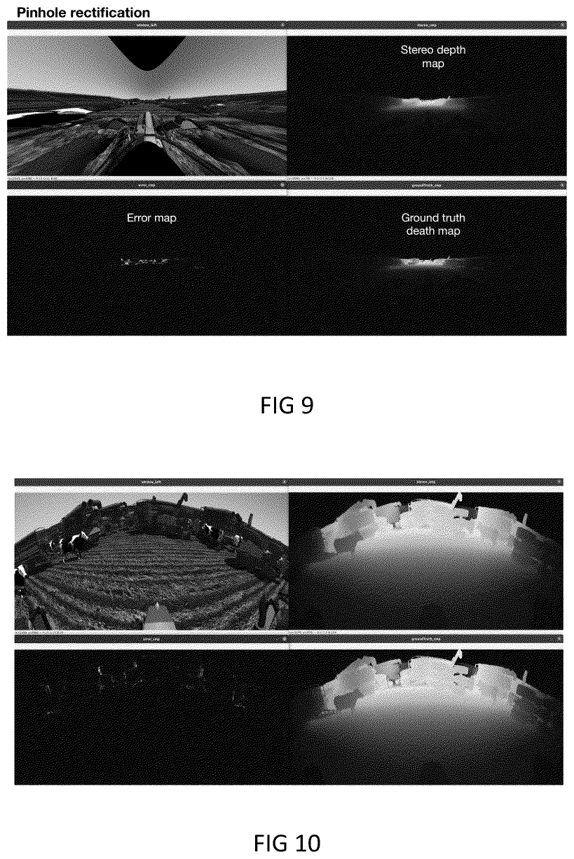

FIGS. 9-10 are a series of simulated illustrations showing the operational use and improvements realized by the present disclosure.

Specifically, in FIG. 9 a representation of an environment obtained through implementation of a conventional “pinhole rectification” is shown, with the graphical representation shown top left, a stereo depth or disparity map shown top right. This is compared with a ground truth obtained for illustrative purposes—bottom right, and an error map generated (bottom right) to illustrate differences between the ground truth and the disparity or depth map produced. Here, a mean squared error value for the rectification is found to be equal to 0.23 m. From the graphical representation is can also be seen that there is a significant distortion of the image at large horizontal field of view angles.

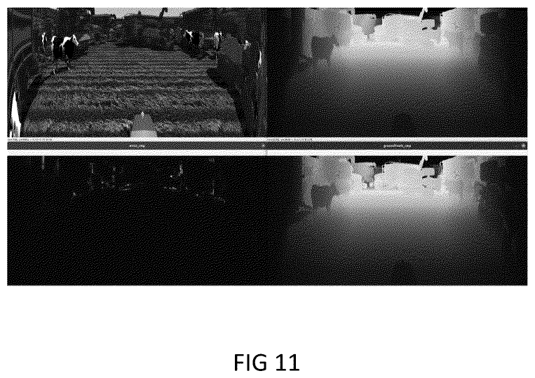

Similar representations are shown in FIGS. 10 and 11, but for a representation of an environment obtained through implementation of a “vertical” and “horizontal” epipolar rectification in accordance with the present disclosure, due to the arrangement of the stereo camera system. The images are laid out in the same way as FIG. 9. Here, for the vertical representation, a mean squared error value for the rectification is found to be equal to 0.15 m, and a significant improvement in the observed distortion at large field of view angles. It is therefore shown that the epipolar rectification proposed by the present disclosure is advantageous over conventional pinhole rectification, particularly at high field of view angles.

### System

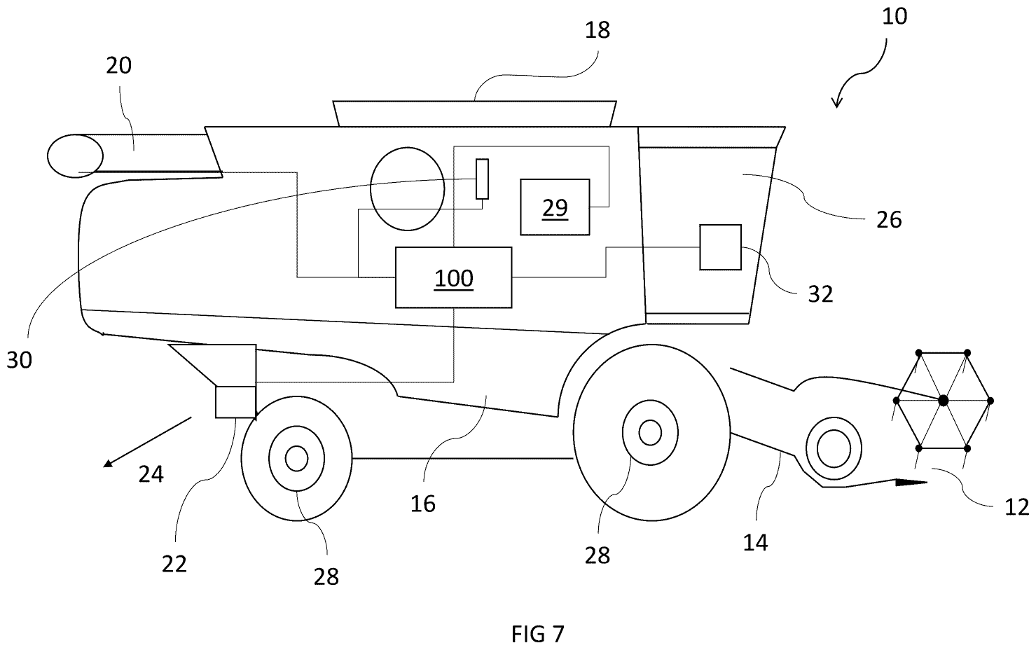

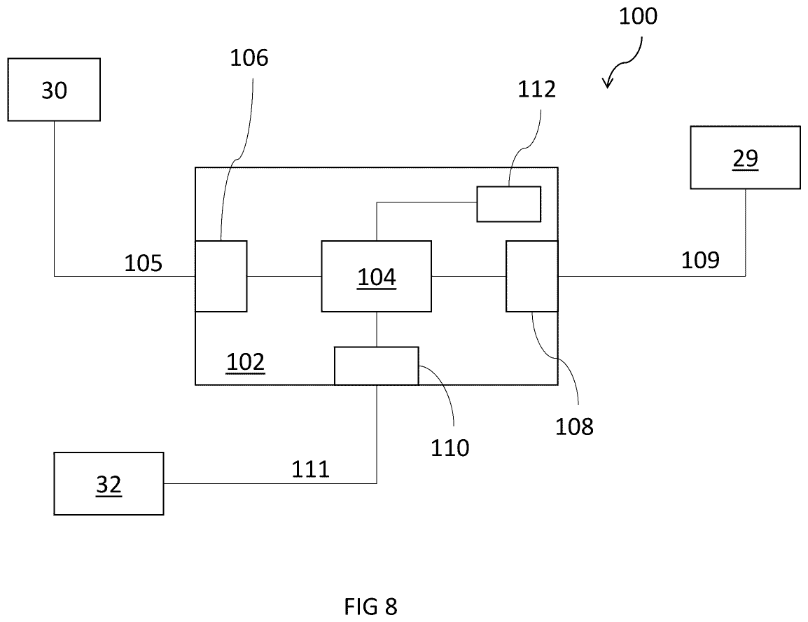

The present disclosure is exemplified here through implementation on an agricultural machine, specifically a combine harvester 10 illustrated in FIG. 7.

The harvester 10 is coupled to a header 12 which is operable, in use, to cut and gather a strip of crop material as the harvester 10 is driven across a field/area to be harvested during a harvesting operation. A conveyor section 14 conveys the cut crop material from the header 12 into a crop processing apparatus 16 operable to separate grain and non-grain (i.e. material other than grain (MOG) or residue material (used interchangeably herein)) as will be appreciated. It is noted here that apparatus for separating grain and non-grain material are well-known in the art and the present disclosure is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilizing unloading auger 20. The remaining non-grain material (MOG)/residue material is separately moved to a spreader tool 22 which is operable in use to eject the non-grain material or MOG from the rear of the harvester 10 and onto the ground. In FIG. 1, this is represented by arrow 24 which illustrates the MOG being ejected rearwards from the harvester 10. It will be appreciated that in some embodiments the harvester 10 may also include a chopper tool positioned, for example, between the crop processing apparatus 16 and the spreader tool 22 and operable, in use, to cut the residue material before it is spread by the spreader tool 22.

The harvester 10 also typically includes, amongst other features, an operator cab 26, wheels 28, engine (not shown) and a user interface in the form of a display terminal 32 provided within the operator cab 26.

The harvester 10 includes a stereo camera system 30 mounted or otherwise coupled to the side of the harvester 10 with a field of view of up to 180 degrees along the side of the harvester 10. The stereo camera system 30 forms part of system 100 and is controllable under operation of a controller 102 described in detail below. In the illustrated embodiment, the stereo camera system 30, or specifically image data obtained thereby may be utilized to monitor and/or at least partly automate operation of an unloading operation of grain material from the harvester 10, e.g. via unloading auger 20 into an adjected collection vehicle, for instance.

FIG. 8 illustrates system 100 of the present disclosure further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present disclosure, for example to output control signals 109 via the output 108 for controlling the display terminal 32 of the harvester 10, for example to provide an image to an operator of the harvester 10, e.g. a generated representation from the image data obtained from the stereo camera system 30.

The processor 104 is operable to receive sensor data via input 106 which, in the illustrated embodiment, takes the form of input signals 105 received from the stereo camera system 30. As described in detail herein, the stereo camera system 30 has a sensing region sidewards of the harvester 10, with the raw image data received from the stereo camera system 30 being indicative of the operating environment corresponding to the sensing region. The processor 104 is operable to process the raw image data in the manner discussed herein to generate a disparity map which is indicative of depth within the working environment. This may beneficially provide, for example, information relating to the distance, or relative orientation of an adjacent vehicle or machine, such as a collection vehicle into which the harvester 10 may unload grain material via unloading auger 20.

Specifically, the processor 104 is operable to process the raw image data through application of an image rectification, specifically here an epipolar image rectification as discussed hereinabove to generate a rectified image data set for the stereo camera system 30. As will be appreciated, this will comprise a pair of data sets from each sensor of the stereo camera system 30. The rectified image data set is then put through a stereo-matching algorithm by the processor 104 to generate the disparity map indicative of depth within the image and hence the working environment of the harvester 10, and one or more operable components of or otherwise associated with the harvester 10 are controlled in dependence on the generated disparity map. Here, this includes generation of control signals by the processor 104 and output via respective outputs 108, 110.

Here, output 108 is operably coupled to a local control unit 29 of the unloading auger 20 for controlling operational parameters thereof. Control signals 109 are generated by processor 104 and output via output 108 to the local control unit 29 for controlling those parameters in dependence on the disparity map generated by the processor 104 based on stereo camera data 30. This may include, for example, an operational speed of components thereof, e.g. to control the flow of material from the unloading auger 20 into an adjacent vehicle, and/or an orientation of the auger 20 with respect to the harvester 10, e.g. to align the auger 20 with the position of the adject vehicle as determined from the generated disparity map.

Output 110 is operably coupled to the display terminal 32 of the harvester 10. Here, the control system 100 is operable to control operation of the display terminal 32, e.g. through output of control signals 111 in order to display operational data to an operator of the harvester 10 relating to the operation of the control system 100. Specifically, the control system 100 may be operable to control the display terminal 32 to display to the operator a graphical representation of the raw and/or rectified image data obtained from the stereo camera system 30, or other useful information. In some variants, the display terminal 32 may also be operable to receive a user input from the operator, and in such instances the output 110 may act as an input for receiving that user input at the processor 104. The user input may relate to a requested or desired unloading auger 20 position, for example, made by the operator of the harvester 10 in view of the distance data determined by the processor 104 in the manner discussed herein.

### Other Embodiments

It will be appreciated that the present disclosure is not limited to the specific operational task discussed above. Rather, the generated disparity map may be suitable for use for a number of operational tasks performed by varying agricultural machines. For instance, where an agricultural machine is for instance a tractor having an implement suitably coupled thereto, the disparity map may be utilized to determine a relative position of the implement with respect to the machine, another associated machine or vehicle, or an environment—e.g. a header position with respect to crop material to be harvested, or an implement position with respect to a ground surface.

Further, the generated disparity map may be utilized as an input to an at least partly automated guidance system for the agricultural machine, serving as an input to determine relative positions of one or more objects, vehicles, machines or the like in the operating environment of the agricultural machine. In turn, this can be used to adjust operating parameters of the machine directly, e.g. a guidance system of the machine for obstacle avoidance, row guidance or the like, for example. Alternatively, the generated disparity map may be graphically represented, e.g. via the display terminal 32, and used by an operator to inform manual guidance of the machine.

In yet further instances, the relative position of a cooperative machine within the agricultural machine's working environment may be determinable from the generated disparity map. In turn, this may be used in a leader follower type automated system, where the agricultural machine may follow the route taken, or work in some form of cooperation with the identified cooperative machine form the generated disparity map.

For different operational tasks, a different orientation or relative arrangement of the stereo camera system may be employed to take advantage of the improvements realized in the field of view. As shown, improvements may be realized across horizontal or vertical fields of view. Where implemented as an implement monitoring system, e.g. as a monitoring system for a header of a harvesting machine, it may be beneficial to utilize improvements in a wide horizontal field of view (e.g. FIG. 10) utilizing a “vertical” epipolar rectification. For embodiments where utilized, e.g. as a monitoring for a trailer system it may be beneficial to utilize improvements in a vertical field of view (e.g. FIG. 11) utilizing a “horizontal” epipolar rectification. Accordingly, the method and systems provided and described herein may advantageously utilize the intended operational task and/or camera orientation or arrangement in determining or formulating the epipolar rectification to utilize the advantages identified herein.

These examples are not to be seen as limiting, but rather provided to exemplify the potential use cases for the improved stereo camera system and associated method discussed herein.

The method and systems described herein have been exemplified by an agricultural implementation. However, the skilled reader would appreciate that the disclosure may extend to other working machines, such as construction machines, transport vehicles and the like, as a minimum. The disclosure may additionally extend to an automotive implementation.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present disclosure can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device, or integrated circuits or on an optically or magnetically readable medium such as, for example, a CD, DVD, magnetic disk, or magnetic tape. It will be appreciated that the storage devices and storage media are embodiments of machine-readable storage that are suitable for storing a program or programs that, when executed, implement embodiments of the present disclosure. Accordingly, embodiments provide a program comprising code for implementing a system or method as set out herein and a machine readable storage storing such a program. Still further, embodiments of the present disclosure may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A computer implemented method for monitoring the operational use of an agricultural machine, the method comprising:
obtaining raw image data from a stereo camera system of or otherwise associated with the agricultural machine;
processing the raw image data through application of an image rectification to generate a rectified image data set;
applying a stereo-matching algorithm on the rectified image data set to generate a disparity map; and
controlling operation of one or more operable components of or otherwise associated with the agricultural machine in dependence on the generated disparity map,
wherein the image rectification comprises an epipolar rectification.

2. The method of claim 1, wherein the epipolar rectification comprises an equidistant epipolar rectification.

3. The method of claim 1, wherein the epipolar rectification is formulated in dependence on one or more characteristics of the stereo camera system.

4. The method of claim 3, wherein the one or more characteristics comprise an orientation or relative arrangement of the stereo camera system.

5. The method of claim 4, wherein the epipolar rectification comprises a remapping of the raw image data which aligns epipolar lines in the raw image data in dependence on an axis relative to the orientation and/or relative arrangement of the stereo camera system.

6. The method of claim 1, comprising analyzing the generated disparity map and/or a generated 3D representation therefrom to identify one or more operational parameters associated with the agricultural machine.

7. The method of claim 6, comprising determining a relative position of one or more operable components of the machine and/or implements operably coupled thereto.

8. The method of claim 7, comprising comparing the determined position with an expected position from respective operational settings for the machine.

9. The method of claim 7, comprising determining a relative position of an unloading auger of the machine or a coupled implement with respect to the machine, an associated machine or vehicle, or an environment.

10. The method of claim 1, comprising utilizing the generated disparity map to identify a relative position of one or more objects, vehicles, machines or the like in the operating environment of the agricultural machine.

11. The method of claim 1, comprising identifying, from the generated disparity map, the relative position of a cooperative machine within the working environment of the agricultural machine.

12. The method of claim 11, comprising determining the relative position of a collection vehicle into which the agricultural machine unloads crop material, in use.

13. The method of claim 12, comprising at least party automating an unloading operation of crop material from the agricultural machine to the collection vehicle in dependence on the determined position, including controlling operable parameters of an unloading auger of the machine, including one or more of an operational speed of components thereof, and/or an operating position with respect to the collection vehicle.

14. A control system comprising one or more controllers configured to perform the method of claim 1.

15. A stereo camera system comprising a pair of cameras; and wherein the system further comprises or is controllable under operation of the control system of claim 14.

16. An agricultural machine comprising the stereo camera system of claim 15.
